(19) United States
(12) Patent Application Publication
(10) Pub. No.: US 2003/0044310 A1
(43) Pub. Date: Mar. 6, 2003

(54) Process and apparatus for controlling bacterial contamination of medical unit waterline and water therein using electric current

(75) Inventors: Masahiro Takahashi, Tokyo (JP); Eisuke Wada, Kanagawa (JP); Toraichi Katsube, Kanagawa (JP); Yoshikazu Hashiguchi, Tokyo (JP)

Correspondence Address: FITCH EVEN TABIN AND FLANNERY, 120 SOUTH LA SALLE STREET, SUITE 1600, CHICAGO, IL, 60603-3406, US

(73) Assignee: Jonan Co., Ltd.

(21) Appl. No.: 09/956,186

(22) Filed: Sep. 19, 2001

(30) Foreign Application Priority Data
Apr. 27, 2001 (JP) 2001-133557

(51) Int. Cl. C02F 1/48

(52) U.S. Cl. 422/22; 204/554; 204/242

(57) ABSTRACT

An anode electrode is disposed to expose in water in a medical waterline, and a cathode is connected to an outer surface cf the waterline electrically conducting to an inner surface of the waterline or exposed in water in the waterline, and by these electrodes, an electric current of an output within the range from 3 to 50 mA is applied to water in the waterline, thereby providing an electric current sterilization method for the medical waterline and water therein, with improved cost effectivity, safety, and sufficient sterilization characteristic.

This application is based on patent applicaticn Ser. No. 2001-133557 filed Apr. 27, 2001 in Japan, the content of which is incorporated hereinto by reference.

### BACKGROUND OF THE INVENTION

1. Field of the Invention

The present invention relates to a sterilization method of medical unit waterline and water therein for effectively performing sterilization or deactivation or prevention of proliferation or growth of bacteria growing in medical unit water line and water therein or on inner wall of water line by applying an electric current or by an electrochemical reaction.

2. Description of the Related Art

In medical unit used in treatment or the like in medical facilities such as dental, ophthalmic, surgical or other fields, water is used for cleaning or the like of the affected part of the patient, and a water pipe is built in for this purpose. This water pipe sometimes extends from the inside to the outside. As the water supplied to the water pipe, drinkable city water is generally used. As the water pipe, a zinc-coated steel pipe or a resin lined steel pipe or a resin pipe is used.

The above drinkable city water is sterilized by chlorination of the Wateworks Bureau, and as a water quality criterion having no bacterial contamination, it is stipulated that concentration in water of hypochlorous acid or hypochlorite ion (hereinafter referred to as residual chlorine) is within a predetermined range. However, water in the medical unit is conducted from the water main pipe, and the residual chlorine concentration after the water main pipe is often below the water quality criterion or not detected if a metal pipe is used in the piping materials, and bacterial contamination in this case is a problem. For example, CRA (Clinical Research Associates) of the U.S. reports pollution circumstances in Clinical Research Associates Newsletter, vol. 21, No. May 5, 1997. Further, also in Japan, “Japan Dental Preservation Magazine, vol. 43, No. 1 16-22, 2000 reports bacterial contamination circumstances and presence of biofilm in the water pipe of dental unit. Most causes thereof are considered to be the use of metal materials in the water pipes or small water flow rate in the unit, or exhaustion of residual chlorine in the water. Still further, in the zinc-coated steel pipe or resin lined steel pipe, the entire pipe inside or metal parts such as joints become corroded with the passage of service time. Yet further, regardless of the pipe material, on the inner wall surface of the water pipe, scale or slime adhere with the passage of time. When metal corrosion or adherence of scale or slime occurs on the inner surface of the water pipe. Bacteria tend to go into the corroded part or adherence pact, where bacteria proliferate to form a so-called biofilm, which leads to even further contamination of water.

As to the relationship between electric current and sterilization, Japanese Patent Laid-open Publication 6-292892(1994) reports a production method of sterilized water and production apparatus thereof by flowing an electric current in water dissolving sodium chloride and an inorganic acid. Japanese Patent Laid-open Publication 11-33086(1999) reports that by applying an electric current directly to an agar medium containing bacteria, it has growth inhibition or sterilization effects on bacteria. However, details thereof are not practical examples, nor current output apparatus is specifically disclosed.

Further, as prior art disclosing apparatus or methods for inhibiting bacterial contamination or sterilization using an electric current, there are reported in Japanese Patent Laid-open Publication 10-237681(1998) Japanese Patent Laid-open Publication 10-290824(1998), Japanese Utility Model Application Laid-open No. 3069670. The technologies of the three examples have been developed mainly by the inventors.

The technology of prior application provides each effect for prevention of bacterial proliferation in the water pipe or sterilization action, however, since its primary object is to prevent corrosion of metal portion by applying a corrosion-proof potential to a metal portion of the water pipe, principle of sterilization effect by electric current has yet to be elucidated, and there is a scope of technical improvement. Specifically examples of scope of technical improvement include occurrence of electric short-circuit phenomenon by adherence of an electrolyte film to the electrode portion, early output decreasing phenomenon due to precipitation of a large amount of calcium or magnesium compounds to the cathode portion in the case of core lined pipes or synthetic resin pipes which become increasingly used as water pipe materials in view of corrosion prevention, appropriate output current value and safety to water to be sterilized, the period until exhibition of sterilization effect, or difference in effect by distance from the electrode mounting position to the water outlet. As to electric short-circuit prevention method which is one of the above problems, an effective electrode structure using the present invention has formerly been proposed in Japanese Patent Application 13-059083(2001). For other matters, when medical unit water is sterilization object, improvement by further studies is required. The matter requiring further improvement is, in particular, the case of dental unit. As shown in FIG. 1, the dental unit makes treatment by inserting the tip of a hand piece, syringe 1, scaler 2 or the like in the mouth while pouring water along with air of a predetermined pressure. When it is attempted to apply the electric current sterilization method to this unit, it Is necessary to control generation of gas by electrolysis of water in the water pipe 3 so that water flow or air flow is not disturbed Further, when the current sterilization apparatus is integrally mounted in the chair unit box as a casing of the dental unit, a further compact structure is required, and it is required to conform to (JIS T-1001 or the like) as medical apparatus safety standards.

### SUMMARY OF THE INVENTION

It is therefore an object of the present invention to provide a process and apparatus for sterilization of medical unit water line and water therein using electric current having a cost effectivity, safety, and sufficient sterilization characteristic which elucidates the requirements capable of enhancing current sterilization effect in the water pipe, safely and most effectively while controlling the relationship between water quality and output current, distance from the electrode mounting position to the water outlet of the treatment unit, and generation of gas by electrolysis of water, which are problems in the case of constructing the current sterilization method and apparatus for medical unlit waterline.

The inventors have conducted intensive studies for solving the problem, performed various experiments on connection of electrode to the water pipe and output control to meet some conditions, and found that it is possible to effectively perform the objective electric current sterilization of medical unit waterline and water therein.

In Japan, electro-conductivity of water used in an ordinary medical unit is within the range from 3 to 60 nS/m (at a water temperature in the range from 2 to 40° C.). In overseas, on the other hand, hard water of a relatively large content of calcium or magnesium or water of a large content of salt is used as city water, and there is a case of showing a value of about 160 mS/m. Electric current sterilization of such water introduced in the water pipe of medical unit has, as shown in FIG. 2, a construction that an anode electrode 5 is disposed so that it is exposed in water in the water pipe, and the other cathode 6 is connected to an outer surface of a metal conducting in the water pipe or a cathode 6 is disposed in water in the water pipe, and an electric current is applied across both electrodes through water in the pipe. It has been found to be important that output voltage, current, and power applied in this case are conditions of 1) shown below.

Further, as the characteristics of a DC output apparatus 7 playing a role of applying an electric current in water through the anode 5 and cathode 6, it is important to satisfy the conditions of the following 2) and 3).

1) an appropriate output current to water through the electrodes 5 and 6 in the water pipe 3 is within the range from 3 to 50 mA, in this range, desirably, the output voltage is within the range from 5 to 30V, and the output power as the multiplied value is within the range from 15 to 1000 mW.

2) a main body output voltage of the DC current output apparatus 7 is typically within the range from 10 to 50 V, in this case, it is desirable that its short-circuit current value is within the range from 5 to 80 mA.

In FIG. 2, reference numeral 8 indicates a DC rectifier, 9 is a transformer, and 10 is an AC power supply.

Accomplished based on the above-described findings, the electric current sterilization method for a medical unit waterline and water therein according to the present invention is characterized in that an anode electrode is disposed to expose in water in the waterline, and a cathode is connected to an outer surface of the waterline electrically conducting to an inner surface of the waterline or exposed in water in the waterline, and by these electrodes, an electric current of an output within the range from 3 to 50 mA is applied to water in the waterline. In controlling within the range of the output current, it is desirable that the output voltage is 5 to 30 V, and the output power as multiplied value of the voltage and the current is 15 to 1000 mW.

Further, the electric current sterilization apparatus for a medical unit waterline and water therein according to the present invention is characterized by comprising: an anode electrode disposed to expose in water in the waterline, a cathode connected to an outer surface of the waterline electrically conducting to an inner surface of the waterline or exposed in water In the waterline, and a DC current output apparatus for applying an electric current within the range from 3 to 50 mA through these electrodes to water in the waterline. In the DC current output apparatus, in controlling the current value, desirably at the voltage of 5 to 30 V, an output power as the multiplied value of the voltage and the current is controlled at 15 to 1000 mW. In the DC current output apparatus, desirably the main body output voltage is set to the range from 10 to 50 V, and its short-circuit current value is set to the range from 5 to 80 mA.

The above and other objects, effects, features and advantage of the present invention will become more apparent from the following description of embodiments thereof in conjunction with the accompanying drawings.

### BRIEF DESCRIPTION OF THE DRAWINGS

FIG. 1 is a schematic construction diagram of a dental unit as an example of medical unit;

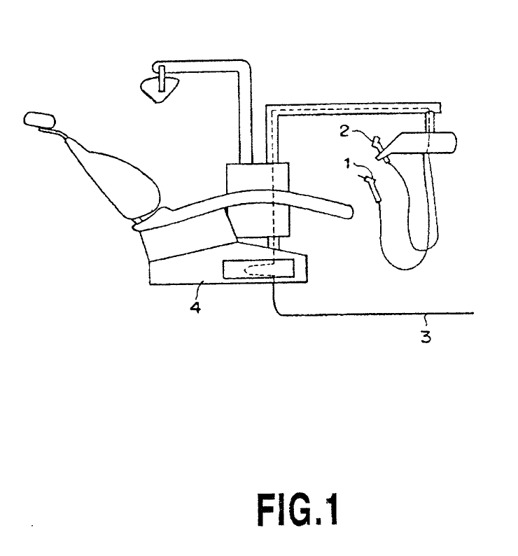

FIG. 2 is a diagram for explaining basic construction of a current sterilization apparatus for medical unit waterline and water thereof according to the present invention;

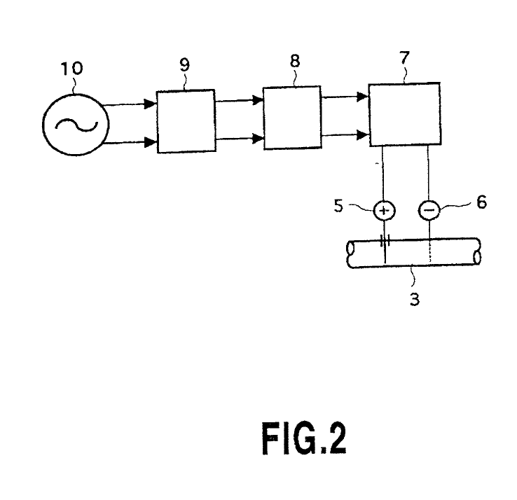

FIG. 3 is a partial perspective diagram showing a modification example of electrode mounting structure in the apparatus according to the present invention, in the case when the apparatus is provided in a chair box of a dental unit;

FIG. 4 is a circuit diagram showing an example of circuit including a constant voltage control circuit and a constant current supply circuit as the subject matter of the apparatus according to the present invention;

FIG. 5 is a circuit diagram showing an example of pulse current supply circuit which may be a subject matter of the apparatus according to the present invention;

FIG. 6 is a construction diagram showing an example of apparatus for reversing voltage application with passage of time performed through electrodes in the apparatus according to the present invention;

FIG. 7 is a graph showing temperature dependence of conductivity of various types of water;

FIG. 8 is a graph showing the relationship between initial chloride ion concentration in water and generation amount of residual chlorine;

FIG. 9 is a diagram showing an embodiment of a construction of the present invention in which an auxiliary anode is disposed at water supply upstream of a water passage open/close valve of a water pipe to accelerate revelation of sterilization action of water.

### DETAILED DESCRIPTION OF PREFERRED EMBODIMENTS

In the present invention of the above construction, distance from the anode electrode mounting position in the water pipe to the exit position of the water pipe, in an ordinary operation environment of medical unit, is preferably less than 5 m in pipe length.

Further, the present invention is considered to be particularly effective when the medical unit is a dental unit for dental treatment.

When both electrodes of the anode and cathode are exposed in water, an output current configuration may be adopted in which positive and negative electrodes are reversed at every length of time.

The conductivity value of water to be applied with the method and apparatus of the present invention is that at a water temperature of 2 to 400° C.

Conductivity of water is determined by ion concentration in water. Most of water used in medical unit is city water, river or underground water as its water source contains inorganic cations mainly of calcium or magnesium and various cations and anions, and concentration thereof varies with regions. These ion concentrations determine the conductivity of water.

Further, inorganic compounds in the dissolved state are also contained in large amounts. Solubilities in water or ionization degrees of these inorganic compounds greatly vary with temperature. In most cases, when temperature increases, solubilities and ionization degrees also increase, which are normally proportional to temperature. An example of the relationship between temperature and conductivity will be described later as a referential example.

Pure water is very high in electrical resistance, for example, conductivity of distilled water in the equilibrium state with the partial pressure of carbon dioxide in the atmosphere is about 0.2 mS/m (20° C.). Since water purified by distillation has been necessarily heat sterilized, it is not necessary to be sterilized again, however, if it is opened to the atmosphere without a bacteria-proof filter at room temperature, bacteria tend to come in, which must be carefully treated. In Japan, conductivity of water to be subjected to current sterilization is 3 to 60 mS/m, which is a value of water actually used. When such water is current sterilized, output voltage to this water is preferably in the range from 5 to 30 V, more preferably 5 to 20 V, particularly preferably within the range from 5 to 15 V. On the other hand, with an eye on water used in medical unit in overseas, since water having a conductivity (>120 mS/m) largely exceeding 60 mS/m is used, to obtain a desired application current value, it is necessary to change the appropriate operation ranges of output voltage and output power.

From the point of view of efficiently performing sterilization by electric current, it is necessary to flow an electric current of more than 3 mA in water. Therefore, as a result, using the present invention, to flow a current effective for sterilization, under the ordinary operation environment in Japan, conductivity of water is preferably more than 3 mS/m. On the other hand, when using water having a conductivity largely exceeding 60 mS/m (in overseas example >120 mS/m), precipitation or deposition of inorganic substances mainly comprising electrically insulating sparingly soluble calcium or magnesium carbonate or hydroxide becomes considerable on the surface of cathode, a current output decreasing phenomenon early occurs, the higher the conductivity of water, the more the conductivity is liable to be affected by temperature, for example, for the same water source, since the conductivity greatly differs between cold season and hot season, more control parts are required for output current control, in view of this point, it is necessary to control the power.

Relation of current (I) and electrical resistance (R) is represented by the relationship I=E/R, and output power (=consumption power) W by W=I×E. Large variation of electrical resistance R of water (reciprocal of conductivity) depending on water quality or temperature is an important problem in the production of the output apparatus. For the present invention, by knowing the range of conductivity to be treated, it is economically possible to incorporate a circuit to follow the charges of conductivity of water in the output control apparatus.

That is, actual water subjected to the current sterilization according to the present invention, in the worldwide point of view, most of it has a conductivity within the range from 3 to 12 mS/m (at a water temperature of 2 to 40° C.), however, from the point of view of ease of sterilization treatment, water of preferably the conductivity within the range from 3 to 80 mS/m (at a water temperature of 2 to 40° C.), in particular preferably the conductivity within the range from 5 to 60 mS/m (water temperature: at 20° C. reference) is advantageously used, most preferably water having the conductivity within the range from 5 to 40 mS/m, however, this is a kind of yardstick. Since supplied water is originally given to the place where the medical unit is installed, if such water of a conductivity of largely out of the standard must be used in the medical unit, when a water quality treatment apparatus for controlling the conductivity of water is provided in addition to the apparatus of the present invention, so to speak, the supply water is pretreated, the supply water is not specifically limited. Determination of 20° C. standard conductivity is performed such that temperature of water to be measured is set to 20° C., and its conductivity is measured.

Next, in the present invention, the object is attained by outputting an electric current in the range from 3 to 50 mA into water, however, it is preferable that within such an output current range, the output voltage is within the range from 5 to 30 V, and the output power which is the multiplied value of the voltage and the current is within the range from 15 to 1000 mW. This will be additionally described further.

When it is assumed that the conductivity of water is within the range from 5 to 120 mS/m (at a water temperature of 2 to 40° C.), that is, in the worldwide point of view, fundamentally, for water of generally used quality, it is not difficult to control generation amount of hydrogen or oxygen gas due to electrolysis of water which is proportional to the sterilization effect and voltage and current values. Generation or production amount of hydrogen or oxygen gas due to electrolysis of water is electrochemically known, and follows to Faraday' law. A problem is the amount of gas produced when a state is continued that electric current is continuously flowed in a closed water pipe with valves closed in the night and holidays and the like. From this point of view, when the present invention is applied, assuming that the above water is used, the output current per hour is appropriately within the range from 3 to 50 mA, preferably within the range from 4 to 30 mA,, more preferably within the range from 4 to 15 mA.

When continuously flowing a current in dead water in the night, holidays and the like, residual chlorine concentration and oxygen radical concentration in the system continue to increase consistently. Further, accumulation of hydrogen gas or oxygen gas is a problem. In such a case, as an alternative method, a timer may be provided which is programmed so that the current sterilization apparatus is started to operate several hours before beginning work after holidays and stopped operating at the end of work.

Next, the reason why the output power as the multiplied value of current and voltage is limited within the range from 15 to 1000 mW will be described. The position of mounting the current sterilization apparatus of the present invention to the medical unit waterline is preferably in the vicinity of the exit of the waterline. This is because, when it is mounted away from the exit, there is the possibility that effectivity of sterilized water decreases or disappears in the waterline. When it is in the vicinity, unnecessary power consumption, gas generation, and leak current can be easily controlled by adjusting the length of the piping. the distance between the medical unit and the electrode will be described later, however, when it is a necessary condition, the output power is within the range from 15 to 1000 mW, more preferably within the range from 30 to 500 mW, most preferably within the range from 40 to 150 mW. As another merit by this limitation, heat generation of the unit can be reduced, whereby the DC current output apparatus can be down-sized.

Next, the principle and function of sterilization by current output into water according to the present invention will be described.

The inventors, as a method for preventing that inside the metal piping as the water pipe (water pipe mainly comprising iron such as zinc-coated steel pipe) is corrode with passage of time, clogged by water called red water containing oxide of iron or by rust blisters, deteriorating supply of water, have formerly put an electric corrosion protection apparatus. From some of red rusted pipes not mounting the apparatus, bacteria exceeding the drinkable water standard have been detected. However, by mounting the apparatus, since reduction of residual chlorine due to reaction with iron has been greatly suppressed, water has become supplied from the tap in the desired sterilized state, and bacteria also have become undetectable. Residual chlorine concentration and its sterilization effect are clearly described in “Sterilization of Water” published by Japan Environmental Service Education Center, “Water Hygienics” published by Gihodo, and the likes

Thereafter, the inventors have continued studies on electric corrosion protection and sterilization, as a result, found that a sterilization action is generated even in the state that the electric corrosion protection apparatus is installed, and residual chlorine is not yet generated. Further, it has been found that, in addition to the fact that current indicates a sterilization effect directly on bacteria, some chemical reactions have sterilization function. One of them is presumed as due to an action of active oxygen such as oxygen radical, hydroxy radical, peroxy radical and the like generated by electrolysis of water. Still further, tolerable concentration of chloride ion as drinkable water is, for example, in Japan, is less than 200 mg/L, even in this case, it has been confirmed that if chloride ion is present, by flowing an electric current, a residual chlorine concentration is generated. Yet further. as another example, when looking overseas, in the water quality standard of Los Angeles in the U.S. upper limit of chloride ion is 500 mg/L, with such water, it has been confirmed that residual chlorine can be generated even further efficiently.

That is, as the principle and function of sterilization by current application into water according to the present invention is assumed to be appearance of residual chlorine originally contained in city water, action of active oxygen by electrolysis of water, regeneration of residual chlorine from chloride ion, and an electric shock to bacteria directly by electric current.

The fundamental construction of the present invention is that, an anode electrode is disposed exposedly in water in a medical unit waterline and water therein, a cathode is connected on the outer surface of the waterline electrically connecting to the inner surface of the waterline, or a cathode is disposed in water in the waterline, the construction of which will be described below.

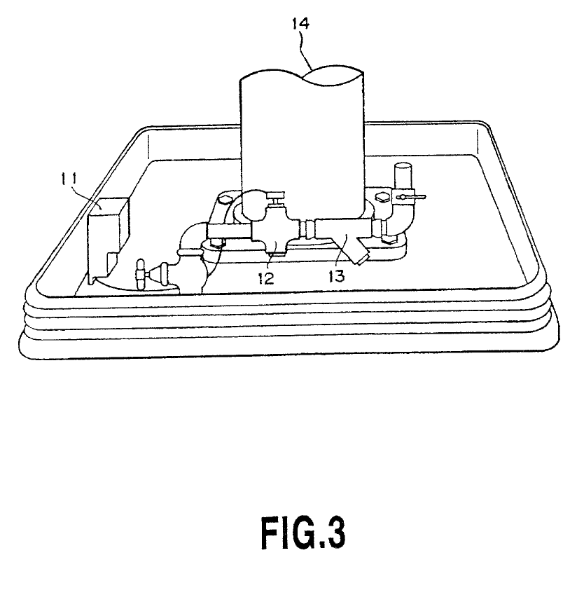

On the construction, as described in the prior art Japanese Patent Laid-open Publication 10-290824(1998), Japanese Patent Laid-open Publication 10-237681(1998), Japanese Utility Model Application Laid-open No. 3069670, in the case that the waterline has a metal pipe such as zinc-coated steel pipe or a metal pipe part, the anode is disposed in the waterline through an electrical insulator so that it is not short-circuited with metal of the piping, and the cathode may be connected to the outer surface of the metal pipe. With this construction, an electric current flows from the anode electrode to the metal pipe as the cathode exposed on the inner surface in the waterline through water in the waterline. In a pipe in which the inside of metal pipe is completely lined with an electrical insulating resin or a synthetic resin pipe, the cathode must be disposed in the pipe. For this kind of pipe, halfway of the pipe, similarly to the prior art, a flange-type joint or a multi-way joint type electrodes, or a flange-type joint in which both the anode and cathode are exposed or a multi-way joint type may be disposed. Further, the anode may be disposed in the strainer of the waterline as well. An example of such construction is shown in FIG. 3. In the figure, numeral 11 denotes a control unit, 12 is a cross anode, 13 is a strainer, and 14 is a leg section of dental chair. Since, in such a construction, if the distance between both electrodes is too small, there is a danger of short-circuit, and if it is too long, it is affected by electrical resistance of water, the distance is 0.5 to 50 cm, more preferably within the range from 1 to 10 cm.

In the present invention, desirably the main body output voltage is set to the range from 10 to 50 V, and its short-circuit current value is set to the range from 5 to 80 mA. The reason of the limitation will be explained.

Further, it may be constructed that the DC current output apparatus is a circuit for rectifying AC current into DC current, a circuit for receiving a rectified current to output a constant current or a pulse current, an electrode inversion output circuit, or the like.

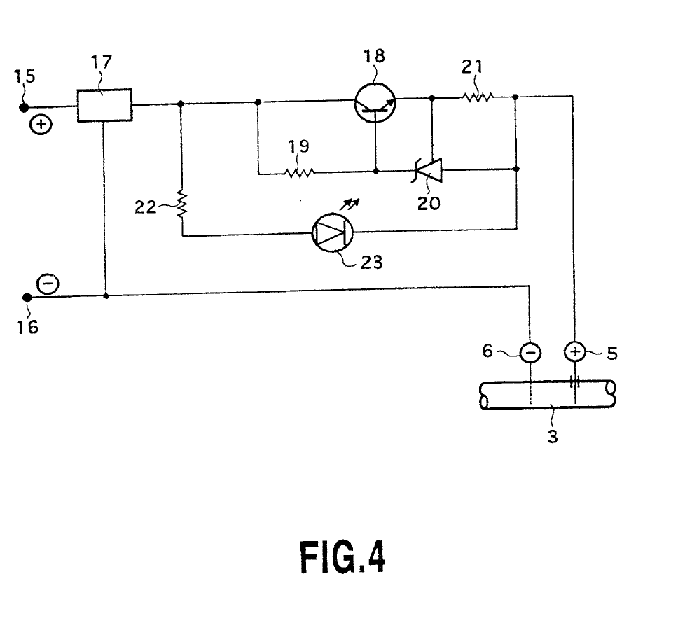

An example of circuit including a constant-voltage control circuit and a constant-current supply circuit constituting the DC current output circuit is shown in FIG. 4.

In the circuit shown in FIG. 4, power applied through connection terminals 15 and 16 from the DC rectifier is controlled by a regulator 17 to a constant voltage and applied to a transistor 18. The transistor 18, a resistor 19, a Zener diode 20 and a resistor 21 are controlled so that the current does not exceed a specified value, thus constructing a constant-current limitation mechanism for supplying a power to the anode 5 and the cathode 6. A light emitting diode 23 displays input of electricity. A resistor 22 suppresses current flowing in the light emitting diode 23 to a minimum.

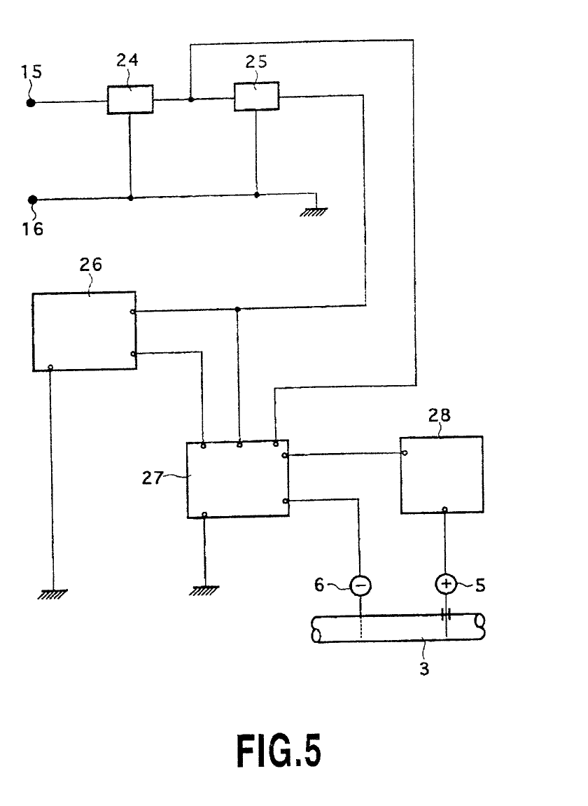

FIG. 5 shows an example of the pulse current supply circuit, in this pulse current supply circuit, power applied through the terminals 15 and 16 is controlled to a high voltage side constant voltage by a regulator 24 and to a low voltage side constant voltage of pulse by a regulator 25. Through a timer circuit 26 and a relay circuit 27, a high voltage and a low voltage are inputted in alternation to a current control mechanism 28. By this operation, a pulse current Is supplied to the anode 5 and the cathode 6.

In the present invention, a DC current output apparatus capable of applying the above output power, current, and power between both electrodes of the anode and cathode disposed in water in the waterline subjected to sterilization, this apparatus is preferably used by integrating into a unit. In such a system, to provide the output current, voltage and power of the appropriate range, it is preferable that a main unit output voltage of current output apparatus is within the range from 5 to 50 V. This voltage value is more preferably within the range from 12 to 30 V, most preferably within the range from 15 to 25 V. Further, the short-circuit current used in the present invention means a limited current value provided to the pair of electrodes (discrete electrodes), to take a safety measure so that more current does not flow even if both electrodes are short circuited. In the present invention, this value is preferably in the range from 5 to 80 mA. Therefore, when a plurality of medical units are disposed in adjacent, only an electrode may be disposed in the respective waterline, and output terminals be provided so that the same currents can be applied to the respective electrodes from the DC current output apparatus. Alternatively, a limited current control member called a limiter may be mounted between the anode electrode and the main body output apparatus. Further, also in such a case, it is preferable in view of safety to limit the maximum voltage×current value outputted from the main body itself. For example, when it is presumed that if leakage of hydrogen gas or ethylene gas occurs in the vicinity of the main body of the DC current output apparatus, the relationship of gas ignition voltage×current is 1000 mA at 15 V, 500 mA at 20 V, 150 mA at 30 V, 80 mA at 40 V, and 60 mA at 50 V, the maximum voltage ×current value outputted from the main body itself is limited in view of safety. Still further, output type of current may be a pulse current. The effect of using such a pulse current is adherence suppression of electrocoating to the cathode electrode. Yet further, by providing a variation of maximum output and minimum output, expansion effects of diffusion area of chlorine at the time of maximum output and/or nascent state oxygen while suppressing the average gas generation amount can be expected

Next, in the present invention, the distance between the anode electrode exposed to water in the medical unit waterline and the waterline exit is preferably within 5 m in pipe length in an ordinary medical unit under ordinary operation environment. This point will be described below. The preferable value range of mounting position of the electrode is for the condition applied to the case where only a pair of electrodes is mounted on the medical unit, as will be described later, when a plurality of electrode pairs are provided as necessary, the condition is applied to only electrode pairs which are always used, but is not specifically applied to other auxiliary electrode pairs.

In the present invention, the anode mounting position in the medical unit waterline, when the anode is the only electrode or an electrode of main role of a plurality of electrodes, is preferably in the vicinity of the waterline exit. This is because, if it is far from the exit, needless to say that, effect of sterilized water is possible to decrease or disappear in the waterline. If it is near, unnecessary power consumption or gas generation and leak current can be easily controlled by adjusting the length of the pipe. When both of anode and cathode electrodes are exposed in water and applied with an electric current, flowing current I has already been shown by I=E/R. As described above, in view or safety when flowing a current in the waterline, it is not desirable to unlimitedly increase the current or voltage according to the distance between the anode and cathode or resistance of water, and it is apparent that the current or voltage is excessively decreased is not desirable because the current is too weak and the sterilization action is poor. In tile electric corrosion protection method as seen in the prior art, due to electrocoating formation in the pipe, after passage of one year, the effect reaches to a distance of 15 m to 30 m, however, such long period of time is not useless in medical applications. In the medical unit, it is desired that when the apparatus is once installed, the effect be provided from that time even gradually. To obtain the effect at early time, output current×voltage and conductivity of water are concerned. On the other hand, as described above, since, when mounting far from the exit, the effect of sterilized water may decrease or disappear in the distance, it is preferable that the electrode be mounted in the vicinity of the waterline exit. In the present invention, this electrode mounting position is preferably within 5 m in pipe length to the waterline exit from the relation to the output, more preferably within 3 m. As the shortest distance, to control leak current at the time of maximum output within a reference value, distance from the water exit is considered to be maintained to several tens of centimeters. Such limitation of mounting range should be applied to the case of only a single electrode in the apparatus, or to a main action electrode when a plurality of electrodes are mounted, but is not necessary to apply to other electrodes of a plurality of electrodes mounted, which has been described above. In this case, other auxiliary electrodes of the plurality of electrodes mounted can be typically, for example, electrodes mounted at the water supply upstream side and/or water supply downstream side of water supply passage closing valves (mainly electromagnetic valves) for preventing degradation of sterilization condition with the passage of time of water stayed in the waterline when the apparatus is not used. In addition, operational auxiliary electrodes are considered for improving the efficiency of sterilization and corrosion protection effects in the apparatus.

The present invention is particularly useful when the medical unit is a dental unit for dental treatment, this point will be described below.

As to the dental unit for dental treatment, in the industry, bacterial contamination of water has become a problem. Literatures on the pollution condition are described in the above-described reports. In the present invention, an object is sterilization of water used in the medical unit and ultimately stopping growth or proliferation of bacteria, when the apparatus of the present invention is experimentally mounted on a dental unit has provided a very satisfactory result. Detailed results thereof will be described later as embodiments.

In the present invention, when both anode and cathode electrodes are exposed in water, a current output configuration of reversing positive and negative electrodes with time may be adopted. This configuration will be described below.

As already described, calcium or magnesium compounds or ions are dissolved in water. These increase the conductivity of water, and are a source of electrocoating formation in electric corrosion protection of a metal pipe, and are thus useful. On the other hand, these adhere as inorganic substances on the surface of cathode electrode and are thus troublesome things which decrease the output current. In the case of a metal pipe, since the entire conducting pipe is a cathode, it is not a substantial problem, however, in the case of a resin-lined pipe or a resin pipe, since the cathode electrode area is limited, if water flow is slow, washing effect is weak, a concentrated adherence phenomenon to the cathode electrode portion tends to occur. As an effective method for preventing this, it is effective to use an electrode made of a material mainly comprising titanium or niobium and plated or cladded with platinum which is applied with a pulse current. A particularly effective method is a method in which an output current of reversing positive and negative electrodes is flowed in the electrode. In the present invention, as the interval of reversing positive and negative electrodes is preferably performed at every relatively snort time when the conductivity of water is high, and as a further yardstick, the hardness of water (calcium, magnesium or the like of water quality standard) is high, when the hardness is low, since precipitation or deposition mainly comprising calcium or magnesium is small, the interval can be increased. This reversing interval is once within 24 hr, more preferably once in 0.25 to 24 hr, particularly preferably once in 1 to 12 hr, which provides an advantageous effect.

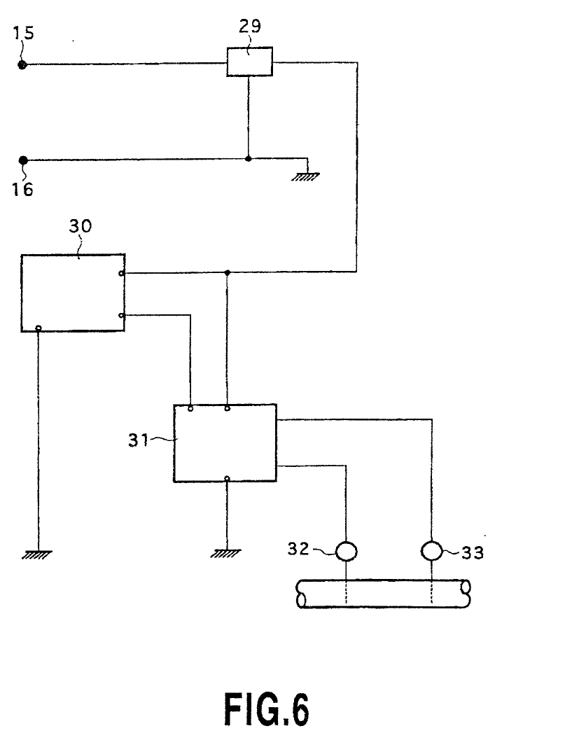

An example of the above application electrode reversing apparatus is shown in FIG. 6. In this apparatus, power applied through the terminals 15 and 16 is controlled to a constant voltage by a regulator 29 and the constant voltage is inputted to a timer 30 and a relay circuit 31. By the function of the timer 30 and the relay circuit 31, a voltage of reversing positive and negative electrodes at every predetermined time is applied to electrodes 32 and 33.

EMBODIMENTS

Next, the present invention will be described further in detail with reference to embodiments and referential embodiments.

Referential Embodiment 1

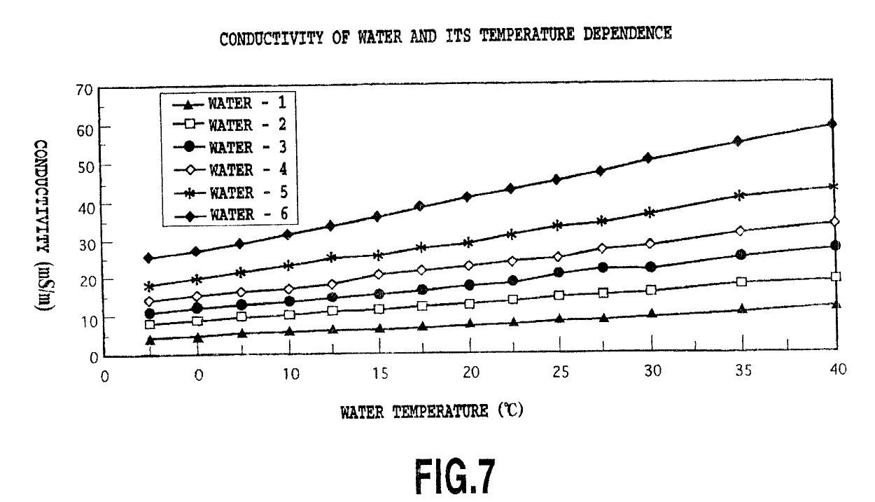

To know the present situation of water to be subjected to sterilization in Japan, several types of water of different conductivities were sampled from various regions, and temperature dependence thereof was measured. The data of the results are shown in Table 1. Further, a graph thereof is shown in FIG. 7. Based oil these results, it is judged that water of a conductivity within the range from 3 to 60 mS/m (at a water temperature in the range from 2 to 40° C.) can be premised as water subjected to sterilization in the present invention. This premise is in Japan, for example, in the water quality standard of Los Angeles of the U.S. an upper limit of conductivity is specified, according to which, conductivity as city water is 1 to 20 mS/m, which cannot be applied similarly in other countries than Japan. Conductivity of home water was actually measured in the eastern area and western area of Los Angeles, the result was about 60 to 80 mS/m.

Referential Embodiment 2

As a referential embodiment, 500 cc of city water of residual chlorine concentration of 0.67 mg/L with a conductivity of 18 mS/m (water temperature 16° C.) was put in a beaker, in which a degreased and polished steel plate (50×100×1.0 cm) was immersed, under moderate stirring, residual chlorine concentration of waver was measured at every hour. Further, the residual chlorine concentration when the steel plate was not immersed was also measured similarly. The measurement results are shownI in Table 2. It can also be seen from the results, residual chlorine is rapidly dissipated where a metal coexists. Further, on the surface of the immersed steel plate taken out after 180 minutes, an apparent corrosion phenomenon was noted.

Embodiment 1

1.8 Liters of city water of residual chlorine concentration of 0.67 mg/L with a conductivity of 18 mS/m (water temperature 16° C.) was put in a beaker, which was covered with a gauze to prevent incoming dust and allowed to stand for one week. This water had a conductivity of 23 mS/m (water temperature 20° C.) but residual chlorine was not detected. 500 cc of this water was put in a beaker, and two platinum-plated wires were inserted as electrodes at an 8 cm interval. While moderately stirring the water, a DC current controlled so that output voltage into water was 18 V and the output current 15 mA through the above electrodes was flowed for 3 hours. During the time, residual chlorine concentration was measured at every hour. The measurement results are shown in Table 3. As a result, formation of residual chlorine proportional to flowed current is confirmed. Further, when formation rate of residual chlorine was calculated from the value, it was 0.0015 mg/L·hr·mA.

TABLE 1
Conductivity of water and temperature dependence
thereof

Temp.

| → | 2.5 | 5 | 7.5 | 10 | 12 5 | 15 | 17.5 | 20 | 22.5 | 25 | 27.5 | 30 | 35 | 40 |
|---|---|---|---|---|---|---|---|---|---|---|---|---|---|---|
| Water- | 4.7 | 5.1 | 5.4 | 5 9 | 6 3 | 6.8 | 7.2 | 7.7 | 8.0 | 8.5 | 9.1 | 9.5 | 10.5 | 11.7 |
| 1 | | | | | | | | | | | | | | |
| Water- | 8.2 | 8.7 | 9.5 | 10.2 | 11.2 | 11.6 | 12.3 | 12.9 | 13.8 | 14.7 | 15.2 | 16.3 | 17.9 | 19.0 |
| 2 | | | | | | | | | | | | | | |
| Water- | 11.2 | 12.0 | 12.9 | 13.9 | 15.0 | 15.9 | 16.5 | 17.6 | 18.9 | 20.5 | 22.0 | 22.4 | 25.0 | 27.0 |
| 3 | | | | | | | | | | | | | | |
| Water- | 14.0 | 15.4 | 16.5 | 17.4 | 18.5 | 20.4 | 21.6 | 22.7 | 23.9 | 25.1 | 27.5 | 28.0 | 32.0 | 34.0 |
| 4 | | | | | | | | | | | | | | |
| Water- | 18.0 | 20.0 | 21.6 | 23.1 | 25.3 | 26.0 | 28.4 | 29.9 | 31.6 | 33.8 | 34.8 | 36.7 | 41.0 | 43.5 |
| 5 | | | | | | | | | | | | | | |
| Water- | 25.8 | 27.5 | 29.4 | 31.7 | 34.1 | 36.0 | 38.3 | 40.6 | 42.5 | 44.8 | 47.5 | 50.0 | 55.0 | 60.0 |
| 6 | | | | | | | | | | | | | | |

TABLE 2
Dissipation of residual chlorine by contact
with iron

| Time passage (min) | 0 | 15 | 30 | 60 | 120 | 180 |
|---|---|---|---|---|---|---|
| Residual chlorine | 0.67 | 0.28 | 0.17 | 0.08 | 0.03 | 0.00 |
| conc. (mg/L) | | | | | | |
| Without steel plate | 0.67 | 0.66 | 0.64 | 0.61 | 0.55 | 0.49 |
| immersion | | | | | | |

TABLE 3
Regeneration of residual chlorine from city
water of exhausted residual chlorine

| Time passage (min) | 0 | 30 | 60 | 120 | 180 | 240 |
|---|---|---|---|---|---|---|
| Residual chlorine conc. | 0.00 | 0.02 | 0.04 | 0.08 | 0.12 | 0.18 |
| (mg/L) | | | | | | |

Embodiment 2

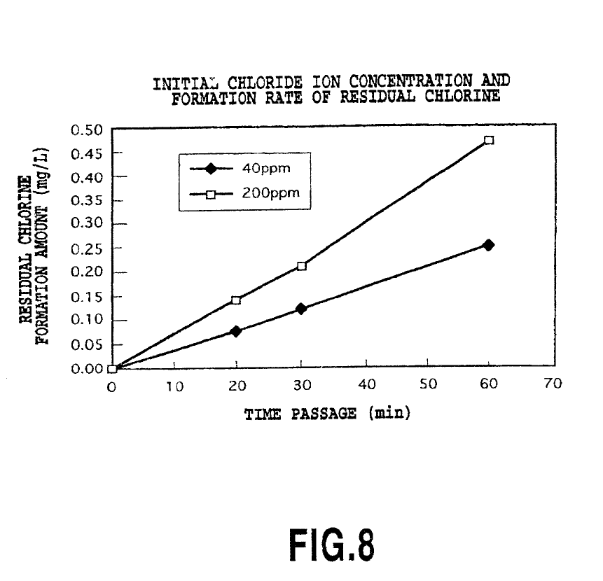

Sodium chloride (class 1 reagent) was dissolved in distilled water to chloride ion concentrations of 40 ppm and 200 ppm. In the water quality standards of drinkable water, a chloride ion concentration of 200 ppm is an upper limit. 500 cc of each solution was put in a beaker, therein two platinum-plated wires were inserted as electrodes at an 8 cm interval. While moderately stirring the water, DC current of a same output was flowed in water through the above electrodes. Flowed currents were 20 mA for the 40 ppm solution, and 42 mA for the 200 ppm solution. Residual chlorine concentration in water was measured. The measurement results are shown in Table 4. A graph of Table 4 is shown in FIG. 8.

As a result, formation of residual chlorine proportional to flowed current was confirmed. Further, when formation rate of residual chlorine was calculated from the value of the 200 ppm solution, it was 0.0056 mg/L·hr·mA.

TABLE 4
Initial chloride ion conc. in water and
formation of residual chlorine

| Time | |
|---|---|
| passage | Initial chloride ion concentration |

| (min) | 40 ppm | 200 ppm |
|---|---|---|
| 0 | 0.00 | 0.00 |
| 20 | 0.07 | 0.14 |
| 30 | 0.12 | 0.21 |
| 60 | 0.25 | 0.47 |

Embodiment 3

Water was sampled from a rainwater catch basin and a waterway which was considered to actually contain Escherichia coli (E. coli), general bacteria and heterotroph bacteria, diluted with residual chlorine exhausted city water to 10 times volume, which were referred to testwaters-1 and 2. Further, a DC power output apparatus of an output voltage of 20 V and a short-circuit current through a limiter of 10 mA was prepared. 500 cc of each water sample was put in a beaker, therein two platinum-plated wires were inserted as electrodes at an 8 cm interval. While moderately stirring the water, through the electrodes from the DC power output apparatus, a current was flowed into water for 14 hours. The flowed current through the electrodes and the applied voltage were 7 mA and 10 V, respectively. As to these water samples, bacteria test results according to Ordinance No. 69 of the Ministry of Health and Welfare are shown in Table 5. In either of water sample applied with electric current, its sterilization effect was apparently confirmed.

TABLE 5
Bacteria culture test result unit: cfu/ml

| | Test | After | Test | After |
|---|---|---|---|---|
| Test item | water −1 | treatment | water −2 | treatment |
| General | 4 | 0 | 3 | 0 |
| bacteria | | | | |
| E coli | 3 | undetected | 3 | undetected |
| Heterotroph | 660 | 0 | 4000 | 0 |
| bacteria | | | | |

Embodiment 4

In Tokyo Medical and Dental University, Department of Mycology, second general clinic room, in a dental unit box used in ordinary dental treatment, a DC power output apparatus (Model: BIOPROTECTOR: by Jonan Co Meguro-ku, Tokyo) was installed. Further, a 15A waterline in the box was connected with a joint incorporated within a platinum electrode (Model CROSSANODE by Jonan Co., cathode connection portion is on the outer surface of the joint). Then, from the above DC power output apparatus, a current was flowed to the disposed cross anode electrode. Conductivity of water in the pipe was 20 mS/m, current flowed to the electrode and the applied voltage were 7.0 mA at 8.6 V. Water sampling results of dental unit turbine water and three-way syringe water before the installation work and bacteria culture test results of water sampled with passage of time after installation of bioprotector are shown in Table 6. Also, after mounting the bioprotector, abnormal phenomenon such as water flow variation or air amount variation from the hand piece during actual treatment was not noted.

TABLE 6
Changes in number of bacteria after mounting
the bioprotector to the dental unit waterline
unit: cfu/ml

| Sampling | | Before | | | |
|---|---|---|---|---|---|
| position | Tested bacteria | current flow | After 2 weeks | After 4 weeks | After 8 weeks |
| Turbine | E coli | 0 | 0 | 0 | 0 |
| | General | undetected | undetected | undetected | undetected |
| | bacteria | | | | |
| | Heterotroph | 41000 | 11000 | 360 | 5 |
| | bacteria | | | | |
| Three-way | E coli | 0 | 0 | 0 | 0 |
| Syringe | General | undetected | undetected | undetected | undetected |
| | bacteria | | | | |
| | Heterotroph | 26,000 | 7900 | 1200 | 0 |
| | bacteria | | | | |

Embodiment 5

In embodiment 5, at Dental Clinic A and Dental Clinic B In Hiroshima, sterilization effect by the apparatus of the present invention was measured. Each dental clinic has two dental unit, in Clinic A, the apparatus of the present invention was installed only in one unit, and in Clinic B, both two units were equipped with the apparatus of the present invention. Since conductivity of water was as low as 5.5 to 6.0 mS/m at each clinic, The DC current output apparatus of output voltage 20 V and short-circuit current through a limiter 20 mA was used. At Clinic A, voltage was 10.3 V and current was 3.9 mA, at Clinic B, voltage was 10.7 V and current was 4.2 to 4.4 mA. The test results are shown in Table 7 and Table 8, respectively.

TABLE 7
Clinic A installation test
(Test organization: Amcon Co.)

Dental

| unit | Sampling | | Initial | After 3 | After 8 |
|---|---|---|---|---|---|
| No. | position | Tested bacteria | value | weeks | weeks |
| A1 | Syringe | General bacteria | 0 | — | 0 |
| (apparatus | | E coli | undetected | — | unde- |
| of present | | | | | tected |
| invention | | Heterotroph | 18000 | 130 | 0 |
| installed) | | bacteria | | | |
| A2 | Turb ne | Heterotroph | 30000 | — | — |
| (present | | bacteria | | | |
| apparatus | Syringe | Heterotroph | 2400 | — | — |
| not | | bacteria | | | |
| installed) | | | | | |
| Control: | Water of | General bacteria | 0 | — | — |
| waterline | entrance | E coli | undetected | — | — |
| out of | toilet | Heterotroph | 1100 | — | — |
| treatment | room | bacteria | | | |
| room | washstand | | | | |

TABLE 8
Clinic B installation test
(Test organization: Hiroshimaken Kankyou Hoken Kyokai)

| Dental unit | Sampling | Tested | Initial | After 3 | After 7 |
|---|---|---|---|---|---|
| No. | position | bacteria | value | weeks | weeks |
| B1 (apparatus | Syringe | General | 0 | 0 | 0 |
| Syringe of | | bacteria | | | |
| present | | E coli | undetected | undetected | undetected |
| invention | | Hetero- | 5700 | 37 | 2 |
| installed) | | troph | | | |
| | | bacteria | | | |
| B2 (apparatus | Syringe | General | 0 | 0 | 0 |
| Syringe of | | bacteria | | | |
| present | | E coli | undetected | undetected | undetected |
| invention | | Hetero- | 820 | 0 | 0 |
| installed) | | troph | | | |
| | | bacteria | | | |

Referential Embodiment 3

Although the sterilization effect of the present invention is difficult to be limited due to active oxygen or current sterilization effect, here the relationship between length of waterline and residual chlorine concentration calculated using formation rate of residual chlorine which is high in sterilization power.

Using residual chlorine formation rate 0.0015 mg/L·hr·mA obtained In above embodiment 2 and residual chlorine formation rate 0.0056 m/L·hr·mA from the value of chloride ion concentration 200 ppm obtained in above embodiment 3, for the relationship between the waterline length as residual chlorine formation amount, model calculated values are shown in Table 10. The size of waterline connected to the medical unit is 15A (inside diameter 15 mm) except for a special case, Table 9 shows calculated inside volume to the length of waterline, that is, water amount (unit: liter) in the waterline. Table 10 is calculated value of the degree of residual chlorine concentration when a 6 mA current is flowed in a 15A pipe for 16 hours (nearly corresponding to one night). In the table, loss rate of 0% value shows a case where residual chlorine is 100% produced in proportion to the current and 100% remained. A loss rate of 50% shows residual chlorine concentration in the pipe, when a 50% loss is assumed due to formation or/and dissipation cf residual chlorine. Similarly, a loss rate of 80% shows residual chlorine concentration in the pipe when an 80% loss is assumed due to formation or/and dissipation of residual chlorine. Degree of formation or/and dissipation of actual residual chlorine in waterline connected to the medical unit cannot be calculated because it is varied by complex factors. However, when calculating by adding an estimated loss rate for reference, to assure a residual chlorine concentration necessary for sterilization according to the water quality standards of more than 0.05 mg/L, preferably 0.07 mg/L, it is found that the pipe length is limited to 7 m, preferably is 5m, and particularly preferable length is within 3 m.

TABLE 9
Inside volume (calculated value) to 15A pipe
length

| | inner | Pipe length (m) and its inside volume (L) | | | | | |
|---|---|---|---|---|---|---|---|
| Pipe | diameter (cm) | 1 | 3 | 5 | 7 | 10 | 15 |
| 15A | 1.5 | 0.710 | 2.120 | 3.530 | 4.950 | 7.070 | 10.600 |

TABLE 10
Calculated values of pipe length and residual
chlorine concentration when 6 mA current is flowed for 16
hr.

| | | Calculated values of pipe | | | | | |
|---|---|---|---|---|---|---|---|
| | | length and residual chlorine | | | | | |
| | | concentration (mg/L) | | | | | |
| Loss rate | Water type | 1 | 3 | 5 | 7 | 10 | 15 |
| Loss 0% | Drawn and kept | 0.20 | 0.07 | 0.04 | 0.03 | 0.02 | 0.01 |
| | water | | | | | | |
| | CL = 200 ppm | 0.76 | 0.25 | 0.15 | 0.11 | 0.08 | 0.05 |
| Loss 50% | Drawn and kept | 0.10 | 0.03 | 0.02 | 0.01 | 0.01 | 0.01 |
| | water | | | | | | |
| | CL = 200 ppm | 0.38 | 0.13 | 0.08 | 0.05 | 0.04 | 0.03 |
| Loss 80% | Drawn and kept | 0.04 | 0.01 | 0.01 | 0.01 | 0.00 | 0.00 |
| | water | | | | | | |
| | CL = 200 ppm | 0.15 | 0.05 | 0.03 | 0.02 | 0.02 | 0.01 |

Embodiment 6

As an embodiment, a DC power output apparatus of a main body output voltage of 20 V with short-circuit currents through a limiter of 6 mA and 10 mA was prepared. In addition to the above, a DC power output apparatus (unit) of a main body output voltage of 10 V with short-circuit currents through a limiter of 7 mA and 12.5 mA and 20 mA was prepared. Further, 6 types of water of different conductivities were prepared. Next, 15A size joints (tradename CROSSANODE: by Jonan Co.) incorporated with platinum electrodes described in Embodiment 5 were prepared for terminal connection portions of the respective DC power output apparatus, and connected to 15A size lined pipes. The anode electrode connection portion was connected with the positive electrode through the above described limiter, and the negative electrode was connected to the designated connection portion on the outer surface of the joint. In the lined pipe having the cross anode joint, a pipe was prepared which was filled with each of the above 6 types of water differing in conductivity. Next, a current was flowed from the above DC power output apparatus to the joint electrode portion. Output voltages of the DC power output apparatus main bodies and short-circuit current values of the limiters and conductivities of various types of water, voltages actually applied to the anode and cathode of the joint, current values flowed through water between the electrodes, and output powers as multiplied values thereof are described in Table 11. In the 10 V output apparatus, even with the enhanced short-circuit current value (output limitation current value) compared to the 20 V output apparatus, the actual output value into water was suppressed to a substantially low value. For example, when comparing the main body output of 20 V×6 mA when using water having a conductivity of 7.5 mS/m of the embodiment with the main body output of 10 V×12.5 mA of the comparative embodiment, in spite of the fact that both cases are the same in multiplied values of output voltage and current of the apparatus main body, either of the actual output value into water was lass than the former apparatus. It is found that in the range of the present invention, this difference can be corrected by increasing the short-circuit current value. Alternatively, it is also found that use of high conductivity water has no problem.

TABLE 11
Output of DC current output unit and
output measurement values to water differing in
conductivity

| Conductiv- | | | | | | |
|---|---|---|---|---|---|---|
| ity of | Unit output | Unit voltage: 10 V | | | Unit voltage: | |
| water | short-circu t | | 12.5 | 20 | 20 V | |
| (mS/m) | current→ | 7 mA | mA | mA | 6 mA | 10 mA |
| 7.5 | Output voltage: | 6.6 | 7.1 | 8.1 | 9.9 | 11.5 |
| | V | | | | | |
| | Output current: | 1.7 | 2.0 | 2.4 | 3.5 | 4.6 |
| | mA | | | | | |
| | Output power: mW | 11.2 | 14.2 | 19.4 | 34.7 | 52.9 |
| 13 | Output voltage: | 6.3 | 6.9 | 8.0 | 8.5 | 10.3 |
| | V | | | | | |
| | Output current: | 2.1 | 2.5 | 3.0 | 4.0 | 5.5 |
| | mA | | | | | |
| | Output power: mW | 13.2 | 17.3 | 24.0 | 34.0 | 56.7 |
| 18 | Output voltage: | 5.8 | 6.4 | 7.4 | 7.4 | 9.3 |
| | V | | | | | |
| | Output current: | 2.7 | 3.4 | 3.7 | 4.3 | 6.1 |
| | mA | | | | | |
| | Output power: mW | 15.7 | 21.8 | 27.3 | 31.8 | 56.7 |
| 23 | Output voltage: | 5.5 | 6.2 | 7.3 | 6.4 | 8.0 |
| | V | | | | | |
| | Output current: | 3.1 | 3.8 | 4.6 | 4.5 | 6.8 |
| | mA | | | | | |
| | Output power: mW | 17.1 | 23.6 | 33.2 | 28.8 | 54.4 |
| 30 | Output voltage: | 5.3 | 6.0 | 7.0 | 7.1 | 7.7 |
| | V | | | | | |
| | Output current: | 3.2 | 4.1 | 5.1 | 4.8 | 6.8 |
| | mA | | | | | |
| | Output power: mW | 17.0 | 24.6 | 35.7 | 33.5 | 52.4 |
| 40 | Output voltage: | 4.9 | 5.5 | 6.6 | 6.4 | 8.0 |
| | V | | | | | |
| | Output current: | 3.8 | 5.0 | 6.2 | 4.8 | 7.1 |
| | mA | | | | | |
| | Output power: mW | 18.4 | 27.5 | 40.6 | 30.7 | 56.8 |

Embodiment 7

As embodiment 7, DC power output apparatus (unit) of main body output voltages of 12 V, 15 V, and 20 V connected with limiters which are distinguished by colors indicating values of short-circuit currents shown in Table 12 to the respective output voltages were prepared. Further, 6 types of water of different conductivities were prepared. Next, 15A size joints (tradename CROSSANODE: by Jonan Co.) incorporated with platinum electrodes described in Embodiment 4 were prepared for terminal connection portions of the respective DC power output apparatus, and connected to 15A size lined pipes. The anode electrode connection portion was connected with the positive electrode through the above described limiter, and the negative electrode was connected to the designated connection portion on the outer surface of the joint. In the lined pipe having the cross anode joint, a pipe was prepared which was filled with each of the above 6 types of water differing in conductivity. Next, a current was flowed from the above DC power output apparatus to the joint electrode portion Output voltages of the DC power output apparatus main bodies and short-circuit current values of the limiters and conductivities of various types of water, voltages actually applied to the anode and cathode of the joint. current values flowed through water between the electrodes, and output powers as multiplied values thereof are described in Table 13. As a result, in the 12 V output unit, output current into water is insufficient with the blue limiter, however, with the yellow limiter, the problem is solved. Further, in the 20 V output unit, even with the blue limiter the target value is attained.

TABLE 12
Main body unit voltages and limiter short-
circuit currents (mA)

| Unit | | | Yel- | Or- | | | | |
|---|---|---|---|---|---|---|---|---|
| output | Black | Blue | low | ange | Red | Brown | Violet | White |
| 12 V | 2.0 | 3.6 | 5.9 | 7.6 | 12.4 | 21.9 | — | 38.3 |
| 15 V | 2.6 | 4.5 | 7.6 | 9.9 | 16.4 | 29.2 | — | 51.9 |
| 20 V | 3.7 | 6.1 | 10.6 | 13.9 | 20.2 | 42.4 | 66 | 7 |
| 25 V | 4.3 | 7.0 | 12.1 | 15.7 | 25.5 | 44.5 | 67 | — |
| 30 V | 5.3 | 8.6 | 15.0 | 19.3 | 31.7 | 55.3 | 67 | — |
| 35 V | 6.2 | 10.0 | 17.4 | 22.5 | 36.7 | 64.0 | — | — |
| 40 V | 7.3 | 11.7 | 20.4 | 26.5 | 43.2 | 67.0 | — | — |

TABLE 13
Combined output measured value of main body unit
and limiter vs. conductivity of water

| Con- | | | | | | | | | | | | | | | | |
|---|---|---|---|---|---|---|---|---|---|---|---|---|---|---|---|---|
| duc- | | | | | | | | | | | | | | | | |
| tivity | Unit → | Unit voltage: 12 V | | | | | Unit voltage: 15 V | | | | | Unit voltage: 20 V | | | | |
| mS/m | Limitter→ | Blue | Yellow | Red | Brown | White | Blue | Yellow | Red | Brown | White | Blue | Yellow | Red | Brown | White |
| 7.5 | Output | 6.3 | 7.0 | 7.9 | 8.3 | 8.6 | 7.8 | 8.9 | 10.3 | 11.0 | 11.2 | 9.9 | 11.5 | 13.6 | 15.3 | 16.2 |
| | voltage: V | | | | | | | | | | | | | | | |
| | Output | 1.8 | 2.3 | 2.7 | 3.0 | 3.2 | 2.4 | 3.0 | 3.6 | 4.0 | 4.4 | 3.5 | 4.6 | 6.2 | 6.6 | 6.7 |
| | current: mA | | | | | | | | | | | | | | | |
| | Output | 11.3 | 16.1 | 21.3 | 24.9 | 27.5 | 18.7 | 26.7 | 37.1 | 44.0 | 49.3 | 34.7 | 52.9 | 84.3 | 1.01 | 109 |
| | power: mW | | | | | | | | | | | | | | | |
| 13 | Output | 5.7 | 6.5 | 7.5 | 8.1 | 8.4 | 7.0 | 7.9 | 9.5 | 10.3 | 11.0 | 8.5 | 10.3 | 12.6 | 14.0 | 15. |
| | voltage: V | | | | | | | | | | | | | | | |
| | Output | 2.1 | 2.6 | 3.4 | 3.8 | 4.1 | 2.7 | 3.6 | 4.7 | 5.4 | 6.0 | 4.0 | 5.5 | 7.8 | 9.4 | 10.5 |
| | current: mA | | | | | | | | | | | | | | | |
| | Output | 12.0 | 16.9 | 25.5 | 30.8 | 34.4 | 18.9 | 28.4 | 44.7 | 55.6 | 66.0 | 34.0 | 56.7 | 98.3 | 132 | 160 |
| | power: mW | | | | | | | | | | | | | | | |
| 18 | Output | 5.2 | 5.9 | 7.0 | 7.7 | 8.2 | 6.3 | 7.1 | 8.8 | 9.9 | 10.5 | 7.4 | 9.3 | 12.0 | 13.6 | 14.7 |
| | voltage: V | | | | | | | | | | | | | | | |
| | Output | 2.2 | 2.9 | 4.0 | 4.7 | 5.2 | 2.9 | 4.0 | 5.6 | 6.7 | 7.4 | 4.3 | 6.1 | 8.5 | 10.2 | 12.4 |
| | current: mA | | | | | | | | | | | | | | | |
| | Output | 11.4 | 17.1 | 28.0 | 36.2 | 42.6 | 18.3 | 28.4 | 49.3 | 66.3 | 77.7 | 31.8 | 56.7 | 102 | 139 | 182 |
| | power: mW | | | | | | | | | | | | | | | |
| 23 | Output | 5.0 | 5.6 | 6.7 | 7.5 | 8.1 | 5.6 | 6.6 | 8.4 | 9.6 | 10.3 | 6.4 | 8.0 | 10.5 | 13.2 | 14.5 |
| | voltage: V | | | | | | | | | | | | | | | |
| | Output | 2.3 | 3.1 | 4.4 | 5.2 | 5.7 | 3.1 | 4.4 | 6.3 | 7.8 | 8.4 | 4.5 | 6.8 | 10.2 | 11.5 | 13.1 |
| | current: mA | | | | | | | | | | | | | | | |
| | Output | 11.5 | 17.4 | 29.5 | 39.0 | 46.2 | 17.4 | 29.0 | 52.9 | 74.9 | 86.5 | 28.8 | 54.4 | 107 | 152 | 190 |
| | power: mW | | | | | | | | | | | | | | | |
| 30 | Output | 5.1 | 5.7 | 6.8 | 7.5 | 8.1 | 5.8 | 6.8 | 8.4 | 9.6 | 10.4 | 7.1 | 7.7 | 11.4 | 13.3 | 14.6 |
| | voltage V | | | | | | | | | | | | | | | |
| | Output | 2.5 | 3.4 | 4.7 | 5.6 | 6.3 | 3.4 | 4.7 | 6.8 | 8.3 | 9.3 | 4.8 | 6.8 | 10.1 | 12.4 | 13.9 |
| | current: mA | | | | | | | | | | | | | | | |
| | Output | 12.8 | 19.1 | 32.0 | 42.0 | 50.6 | 19.7 | 32.0 | 57.1 | 79.7 | 96.7 | 33.5 | 52.4 | 115 | 165 | 203 |
| | power. mW | | | | | | | | | | | | | | | |
| 40 | Output | 4.8 | 5.5 | 6.6 | 7.4 | 8.0 | 5.5 | 6.5 | 8.2 | 9.4 | 10.3 | 6.4 | 8.0 | 10.8 | 12.7 | 14.4 |
| | voltage: V | | | | | | | | | | | | | | | |
| | Output | 2.5 | 3.4 | 5.0 | 6.1 | 6.9 | 3.4 | 4.9 | 7.2 | 8.8 | 10.1 | 4.8 | 7.1 | 10.9 | 13.6 | 15.8 |
| | current: mA | | | | | | | | | | | | | | | |
| | Output | 12.0 | 18.7 | 33.0 | 45.1 | 55.2 | 18.7 | 31.9 | 59.0 | 82.7 | 104 | 30.7 | 56.8 | 118 | 173 | 228 |
| | power: mW | | | | | | | | | | | | | | | |

Embodiment 8

As embodimnent 8, DC power output apparatus (unit) of main body output voltages of 25 V, 30 V, 35 V, and 40 V connected with limiters which are distinguished by colors indicating values of short-circuit currents shown in Table 14 to the respective output voltages were prepared. Further, 6 types of water of different conductivities were prepared. Next, 15A and 20A size joints (tradename CROSSANODE: by Jonan Co.) incorporated with platinum electrodes described in Embodiment 5 were prepared for terminal connection portions of the respective DC power output apparatus, and connected to the same size lined pipes. The anode electrode connection portion was connected with the positive electrode through the above described limiter, and the negative electrode was connected to the designated connection portion on the outer surface of the joint. In the lined pipe having the cross anode joint, a pipe was prepared which was filled with each of the above 6 types of water differing in conductivity. Next, a current was flowed from the above DC power output apparatus to the joint electrode portion. Output voltages of the DC power output apparatus main bodies and short-circuit current values of the limiters and conductivities of various types of water, voltages actually applied to the anode and cathode of the joint, current values flowed through water between the electrodes, and output powers as multiplied values thereof are describes in Tables 14, 15, 16, and 17. From these results, in the case where the unit voltage is 40 V, when the limiter current is brown (67 mA), the output power as the multiplied value thereof does not exceed 1000 mW. From these values, it can also be estimated from calculation that the object of the present invention can be attained by selecting a limiter with reference to conductivity of water if the unit output is less than 50 V.

TABLE 14
Combined output measured value of main body
unit and limiter vs. conductivity of water

| Conductivity | Unit → | Unit voltage: 25 V:15 A | | | | | | Unit voltage: 25 V:20 A | | | | | |
|---|---|---|---|---|---|---|---|---|---|---|---|---|---|
| mS/m | Limitter→ | Blue | Yellow | Orange | Red | Brown | Violet | Blue | Yellow | Orange | Red | Brown | Violet |
| 7.5 | Output | 12.6 | 14.5 | 15.5 | 17.0 | 18.5 | 19.3 | 10.5 | 12.7 | 16.9 | 16.1 | 17.7 | 18.6 |
| | voltage: V | | | | | | | | | | | | |
| | Output | 4.0 | 5.2 | 5.7 | 6.5 | 7.0 | 7.2 | 4.8 | 6.4 | 7.1 | 7.8 | 8.9 | 9.8 |
| | current: mA | | | | | | | | | | | | |
| | Output power: | 50.4 | 75.4 | 88.4 | 111 | 129 | 139 | 50.4 | 81.3 | 120 | 126 | 158 | 182 |
| | mW | | | | | | | | | | | | |
| 13 | Output | 10.5 | 12.9 | 14.0 | 15.9 | 17.6 | 18.7 | 9.0 | 11.4 | 12.5 | 14.6 | 16.7 | 17.9 |
| | voltage: V | | | | | | | | | | | | |
| | Output | 4.7 | 6.2 | 7.0 | 8.2 | 9.1 | 9.8 | 5.3 | 7.2 | 8.1 | 9.8 | 11.1 | 12.2 |
| | current: mA | | | | | | | | | | | | |
| | Output power: | 49.4 | 80.0 | 98.0 | 130 | 160 | 183 | 47.7 | 81.2 | 101 | 143 | 185 | 218 |
| | mW | | | | | | | | | | | | |
| 18 | Output | 9.0 | 11.2 | 12.4 | 14.6 | 16.5 | 17.8 | 7.5 | 9.5 | 10.6 | 12.6 | 14.8 | 16.6 |
| | voltage: V | | | | | | | | | | | | |
| | Output | 5.3 | 7.3 | 8.2 | 9.9 | 11.5 | 12.7 | 5.8 | 8.4 | 9.8 | 12.7 | 15.5 | 17.5 |
| | current: mA | | | | | | | | | | | | |
| | Output power: | 40.3 | 81.8 | 102 | 144 | 190 | 226 | 43.5 | 79.8 | 104 | 160 | 229 | 291 |
| | mW | | | | | | | | | | | | |
| 23 | Output | 8.1 | 10.2 | 11.3 | 13.5 | 15.6 | 17.2 | 6.7 | 8.5 | 9.4 | 11.7 | 14.1 | 15.9 |
| | voltage: V | | | | | | | | | | | | |
| | Output | 5.5 | 7.9 | 9.1 | 11.3 | 13.4 | 14.9 | 6.1 | 9.1 | 10.8 | 14.0 | 17.5 | 20.2 |
| | current: mA | | | | | | | | | | | | |
| | Output power: | 44.6 | 80.2 | 103 | 152 | 209 | 256 | 40.9 | 76.9 | 102 | 164 | 247 | 321 |
| | mW | | | | | | | | | | | | |
| 30 | Output | 7.3 | 9.5 | 10.6 | 12.8 | 14.8 | 16.5 | 6.2 | 7.9 | 8.9 | 11.0 | 13.3 | 15.2 |
| | voltage: V | | | | | | | | | | | | |
| | Output | 5.9 | 8.4 | 9.7 | 12.4 | 15.6 | 17.6 | 6.2 | 9.4 | 11.2 | 15.0 | 19.5 | 23.2 |
| | current: mA | | | | | | | | | | | | |
| | Output power: | 42.7 | 79.4 | 103 | 158 | 231 | 290 | 38.4 | 74.3 | 99.7 | 164 | 259 | 351 |
| | mW | | | | | | | | | | | | |
| 40 | Output | 6.3 | 8.0 | 8.8 | 10.9 | 13.4 | 15.4 | 5.4 | 6.8 | 7.5 | 9.4 | 12.0 | 14.1 |
| | voltage: V | | | | | | | | | | | | |
| | Output | 6.1 | 9.2 | 11.1 | 14.9 | 19.4 | 22.5 | 6.5 | 10.1 | 12.4 | 17.2 | 23.1 | 28.4 |
| | current: mA | | | | | | | | | | | | |
| | Output power: | 38.2 | 73.6 | 98.1 | 162 | 260 | 347 | 35.2 | 68.2 | 93.0 | 162 | 277 | 400 |
| | mW | | | | | | | | | | | | |

TABLE 15
Combined output measured value of main body
unit and limiter vs. conductivity of water

| Conductivity | Unit → | Unit voltage: 30 V:15 A | | | | | | Unit voltage: 30 V:20 A | | | | | |
|---|---|---|---|---|---|---|---|---|---|---|---|---|---|
| mS/m | Limitter→ | Blue | Yellow | Orange | Red | Brown | White | Blue | Yellow | Orange | Red | Brown | White |
| 7.5 | Output | 14.9 | 17.5 | 18.9 | 21.2 | 22.8 | 21.0 | 12.5 | 15.3 | 16.3 | 18.9 | 21.2 | 23.0 |
| | voltage: V | | | | | | | | | | | | |
| | Output | 4.9 | 6.6 | 7.2 | 7.9 | 8.8 | 9.1 | 5.7 | 7.9 | 9.2 | 10.8 | 12.2 | 12.3 |
| | current: mA | | | | | | | | | | | | |
| | Output power: | 73.0 | 116 | 136 | 167 | 201 | 218 | 71.0 | 120 | 150 | 204 | 259 | 283 |
| | mW | | | | | | | | | | | | |
| 13 | Output | 12.4 | 15.4 | 16.6 | 19.4 | 21.5 | 23.0 | 10.0 | 12.9 | 14.4 | 17.1 | 19.7 | 21.4 |
| | voltage: V | | | | | | | | | | | | |
| | Output | 6.0 | 8.1 | 9.2 | 10.6 | 12.0 | 13.0 | 6.7 | 9.4 | 10.9 | 13.3 | 15.6 | 17.6 |
| | current: mA | | | | | | | | | | | | |
| | Output power: | 74.1 | 125 | 153 | 206 | 258 | 299 | 67.0 | 121 | 157 | 227 | 307 | 377 |
| | mW | | | | | | | | | | | | |
| 18 | Output | 10.7 | 13.6 | 15.1 | 17.7 | 20.3 | 22.0 | 8.8 | 11.4 | 13.0 | 16.0 | 18.8 | 20.9 |
| | voltage: V | | | | | | | | | | | | |
| | Output | 6.6 | 9.4 | 10.6 | 13.1 | 15.3 | 17.0 | 7.4 | 10.7 | 12.4 | 15.9 | 19.4 | 21.8 |
| | current: mA | | | | | | | | | | | | |
| | Output power: | 70.6 | 127 | 160 | 232 | 311 | 374 | 65.1 | 122 | 161 | 254 | 365 | 456 |
| | mW | | | | | | | | | | | | |
| 23 | Output | 9.3 | 12.3 | 13.6 | 16.4 | 19.2 | 20.1 | 8.0 | 10.5 | 11.9 | 14.7 | 17.6 | 19.9 |
| | voltage: V | | | | | | | | | | | | |
| | Output | 7.2 | 10.3 | 12.0 | 15.2 | 18.3 | 20.8 | 7.7 | 11.5 | 13.6 | 17.8 | 22.4 | 26.1 |
| | current: mA | | | | | | | | | | | | |
| | Output power: | 67.0 | 127 | 163 | 248 | 350 | 418 | 61.6 | 120 | 162 | 262 | 394 | 519 |
| | mW | | | | | | | | | | | | |
| 30 | Output | 9.1 | 11.9 | 13.3 | 16.2 | 19.0 | 21.1 | 6.7 | 8.7 | 9.9 | 12.9 | 16.0 | 18.6 |
| | voltage: V | | | | | | | | | | | | |
| | Output | 7.4 | 10.5 | 12.3 | 15.6 | 19.0 | 21.3 | 8.3 | 12.8 | 15.5 | 20.6 | 27.0 | 32.0 |
| | current: mA | | | | | | | | | | | | |
| | Output power: | 66.9 | 124 | 164 | 252 | 361 | 449 | 55.3 | 111 | 153 | 266 | 432 | 595 |
| | mW | | | | | | | | | | | | |
| 40 | Output | 7.1 | 9.3 | 10.6 | 13.2 | 16.5 | 18.9 | 6.4 | 8.4 | 9.5 | 12.0 | 15.1 | 17.7 |
| | voltage: V | | | | | | | | | | | | |
| | Output | 8.1 | 12.5 | 14.9 | 20.6 | 25.7 | 30.4 | 8.4 | 13.1 | 15.8 | 22.0 | 29.4 | 35.8 |
| | current: mA | | | | | | | | | | | | |
| | Output power: | 57.5 | 116 | 158 | 272 | 424 | 575 | 53.5 | 109 | 150 | 264 | 443 | 634 |
| | mW | | | | | | | | | | | | |

TABLE 16
Combined output measured value of main body
unit and limiter vs. conductivity of water

| Conductivity | Unit → | Unit voltage: 35 V:15 A | | | | | | Unit voltage: 35 V:20 A | | | | | |
|---|---|---|---|---|---|---|---|---|---|---|---|---|---|
| mS/m | Limitter→ | Black | Blue | Yellow | Orange | Red | Brown | Black | Blue | Yellow | Orange | Red | Brown |
| 7.5 | Output voltage: | 12.2 | 16.0 | 20.0 | 21.8 | 24.5 | 26.6 | 10.9 | 13.6 | 17.1 | 18.7 | 21.5 | 24.7 |
| | V | | | | | | | | | | | | |
| | Output current: | 4.8 | 6.5 | 8.2 | 8.8 | 9.8 | 10.6 | 5.1 | 7.4 | 10.2 | 11.6 | 14.2 | 15.4 |
| | mA | | | | | | | | | | | | |
| | Output power: mW | 58.6 | 104 | 164 | 192 | 240 | 281 | 55.6 | 101 | 174 | 217 | 305 | 380 |
| 13 | Output voltage: | 10.4 | 13.6 | 17.4 | 19.1 | 22.1 | 24.8 | 8.9 | 11.2 | 14.7 | 16.4 | 19.8 | 22.9 |
| | V | | | | | | | | | | | | |
| | Output current: | 5.3 | 7.5 | 10.0 | 11.1 | 13.3 | 14.9 | 5.7 | 8.4 | 11.9 | 13.7 | 17.0 | 20.1 |
| | mA | | | | | | | | | | | | |
| | Output power: mW | 55.1 | 102 | 174 | 212 | 294 | 370 | 50.7 | 94.1 | 175 | 225 | 337 | 460 |
| 18 | Output voltage: | 9.0 | 11.9 | 15.0 | 16.9 | 19.7 | 23.0 | 7.5 | 9.7 | 12.9 | 14.6 | 17.9 | 21.3 |
| | V | | | | | | | | | | | | |
| | Output current: | 5.6 | 8.1 | 11.5 | 13.2 | 16.8 | 19.5 | 6.0 | 8.9 | 13.1 | 15.3 | 19.6 | 24.0 |
| | mA | | | | | | | | | | | | |
| | Output power: mW | 50.4 | 96.4 | 173 | 223 | 331 | 449 | 45.0 | 86.3 | 169 | 223 | 351 | 511 |
| 23 | Output voltage: | 7.9 | 10.3 | 13.6 | 15.4 | 18.7 | 21.9 | 6.4 | 8.3 | 11.0 | 12.8 | 15.9 | 19.6 |
| | V | | | | | | | | | | | | |
| | Output current: | 5.9 | 8.7 | 12.5 | 14.7 | 18.5 | 22.7 | 6.3 | 9.5 | 14.5 | 17.0 | 22.8 | 28.9 |
| | mA | | | | | | | | | | | | |
| | Output power: mW | 46.6 | 89.6 | 170 | 226 | 345 | 497 | 40.3 | 78.4 | 159 | 218 | 363 | 566 |
| 30 | Output voltage: | 7.2 | 9.4 | 12.7 | 14.5 | 17.7 | 21.0 | 6.0 | 7.7 | 10.3 | 11.7 | 15.0 | 18.5 |
| | V | | | | | | | | | | | | |
| | Output current: | 6.1 | 9.0 | 13.2 | 15.4 | 19.9 | 24.7 | 6.3 | 9.7 | 14.8 | 17.8 | 24.0 | 31.1 |
| | mA | | | | | | | | | | | | |
| | Output power: mW | 43.9 | 84.6 | 167 | 223 | 352 | 519 | 37.8 | 74.7 | 152 | 208 | 360 | 575 |
| 40 | Output voltage: | 6.1 | 7.9 | 10.4 | 12.0 | 15.3 | 18.8 | 5.3 | 6.6 | 8.7 | 10.1 | 12.0 | 16.6 |
| | V | | | | | | | | | | | | |
| | Output current: | 6.3 | 9.6 | 14.8 | 17.5 | 23.5 | 30.8 | 6.5 | 10.1 | 15.9 | 19.4 | 27.2 | 36.7 |
| | mA | | | | | | | | | | | | |
| | Output power: mW | 38.4 | 75.1 | 154 | 210 | 359 | 579 | 34.1 | 66.7 | 138 | 196 | 326 | 609 |

TABLE 17
Combined output measured value of main body
unit and limiter vs. conductivity of water

| Conductivity | Unit → | Unit voltage: 40 V:15 A | | | | | | Unit voltage: 40 V:20 A | | | | | |
|---|---|---|---|---|---|---|---|---|---|---|---|---|---|
| mS/m | Limitter→ | Black | Blue | Yellow | Orange | Red | Brown | Black | Blue | Yellow | Orange | Red | Brown |
| 7.5 | Output | 148 | 193 | 211 | 252 | 28.4 | 311 | 130 | 167 | 21.2 | 233 | 267 | 293 |
| | voltage: V | | | | | | | | | | | | |
| | Output | 5.5 | 7.2 | 9.5 | 10.6 | 121 | 130 | 5.9 | 82 | 11.1 | 12.3 | 145 | 16.5 |
| | current: mA | | | | | | | | | | | | |
| | Output power: | 81.4 | 141 | 222 | 267 | 344 | 404 | 767 | 137 | 234 | 287 | 387 | 492 |
| | mW | | | | | | | | | | | | |
| 13 | Output | 11.9 | 15.8 | 204 | 22.4 | 26.2 | 293 | 9.8 | 12.8 | 168 | 19.1 | 228 | 271 |
| | voltage: V | | | | | | | | | | | | |
| | Output | 6.4 | 8.9 | 119 | 13.5 | 16.1 | 18.3 | 6.5 | 9.5 | 13.8 | 15.8 | 19.9 | 23.0 |
| | current: mA | | | | | | | | | | | | |
| | Output power: | 76.2 | 141 | 243 | 302 | 422 | 536 | 63.4 | 122 | 232 | 302 | 454 | 623 |
| | mW | | | | | | | | | | | | |
| | Output | 10.0 | 12.4 | 169 | 19.3 | 23.5 | 275 | 84 | 11.0 | 14.9 | 16.9 | 20.9 | 250 |
| 18 | voltage: V | | | | | | | | | | | | |
| | Output: | 6.8 | 10.1 | 144 | 16.4 | 20.3 | 239 | 72 | 10.7 | 15.8 | 18.5 | 23.8 | 29.9 |
| | current: mA | | | | | | | | | | | | |
| | Output power: | 680 | 125 | 243 | 317 | 477 | 657 | 605 | 118 | 235 | 313 | 497 | 748 |
| | mW | | | | | | | | | | | | |
| 23 | Output | 90 | 11.9 | 15.7 | 175 | 218 | 25.7 | 7.4 | 9.7 | 13.1 | 151 | 18.9 | 23.3 |
| | voltage: V | | | | | | | | | | | | |
| | Output | 71 | 10.4 | 15.2 | 18.0 | 22.9 | 27.8 | 7.5 | 11.2 | 17.0 | 20.2 | 27.0 | 34.3 |
| | current: mA | | | | | | | | | | | | |
| | Output power: | 63.9 | 123 | 239 | 315 | 495 | 714 | 55.5 | 109 | 223 | 305 | 510 | 799 |
| | mW | | | | | | | | | | | | |
| 30 | Output | 8.1 | 10.7 | 14.5 | 16.5 | 20.5 | 24.5 | 6.8 | 8.8 | 12.1 | 13.9 | 17.6 | 22.0 |
| | voltage: V | | | | | | | | | | | | |
| | Output | 73 | 108 | 160 | 18.8 | 24.6 | 310 | 76 | 11.5 | 17.7 | 21.3 | 28.8 | 38.0 |
| | current: mA | | | | | | | | | | | | |
| | Output power: | 591 | 116 | 232 | 310 | 504 | 780 | 513 | 101 | 214 | 296 | 507 | 836 |
| | mW | | | | | | | | | | | | |
| 40 | Output | 68 | 89 | 122 | 140 | 17.8 | 220 | 5.8 | 74 | 100 | 115 | 15.0 | 191 |
| | voltage: V | | | | | | | | | | | | |
| | Output | 75 | 114 | 17.6 | 21.1 | 28.3 | 37.3 | 78 | 121 | 191 | 23.4 | 33.0 | 453 |
| | current: mA | | | | | | | | | | | | |
| | Output power: | 510 | 101 | 214 | 295 | 504 | 821 | 45.2 | 895 | 191 | 269 | 495 | 865 |
| | mW | | | | | | | | | | | | |

Embodiment 9

The present embodiment shows a practical example of construction of providing a plurality of electrode pairs as electrodes of current sterilization apparatus to the medical unit, describes a construction in which a where electrode pair is added for maintaining sterilized water quality at stopping operation and restarting operation of the medical unit in a good condition, so that restarting operation of the medical unit can always be rapidly performed.

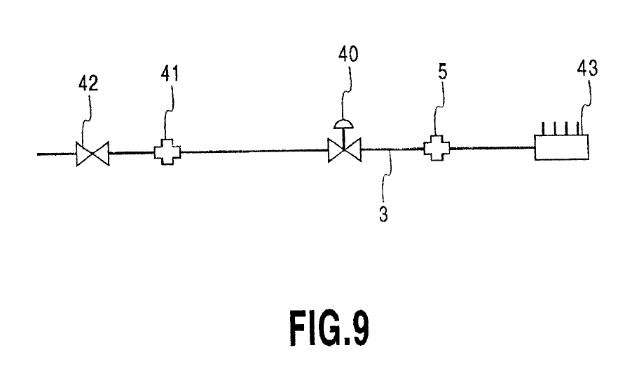

In most medical units, for example, in the case of a dental treatment unit, in the waterline after the initial valve of water supply, an electric or manual valve is often provided. For example, for water supplied to a hand piece of syringe Curing treatment, by hand operation or foot operation, the halfway valve (electromagnetic valve) is opened and closed. At the water supply side upstream of the valve, there is often provided a further stop valve. Further, when, by turning off the power supply of the treatment unit at the completion of treatment, the electromagnetic valve (or manual valve) is closed to shut down water supply, depending on the position where the electrode of the current sterilization apparatus of the present invention is mounted, the period of time until the effect to the entire waterline of the treatment unit is changed. In the current sterilization apparatus of the present invention, since the anode is placed in water, when water distribution circuit is cut off by the valve, water in the waterline after the valve is not supplied with electric current. In the current sterilization apparatus of the present invention, in order to provide the maximum effect, it is desirable to form a state of flowing electric current in the entire waterline irrespective of operation and stoppage of the subjected treatment unit (medical unit). As an example for this purpose, in the present embodiment, as shown in FIG. 9, an auxiliary anode 41 is provided at the upstream side of the closing valve 40 in addition to the main role anode 5 provided at the downstream side (water distributor 43 side for treatment water) of the closing valve (electromagnetic valve) 40 disposed in the waterline 3. In the construction shown in the figure, the auxiliary anode 41 is provided between the closing valve 40 and the further.upstream side stop valve 42, however, when the stop valve 42 remains opened, the auxiliary anode 41 may be provided at the upstream side of the stop valve 42. Further, in addition to the shown auxiliary anode 41, a further auxiliary anode may be provided at the upstream side of the stop valve regardless of opening and closing of the stop valve.

In the construction of the present embodiment, since generation gas produced by applying current into the waterline with stopped water flow by the closing valve 40 may accumulate, to deal with this, it is desirable to provide a relief valve or a gas purge valve at an appropriate position in the closed waterline.

Further, in the construction of FIG. 9, as described above, the main role anode 5 is desirably disposed at the waterline exit side of the closing valve provided in the waterline, within 5m from the treatment water exit (waterline exit), however, the auxiliary anode 41 does not require such a limitation. Still further, in the present invention, the medical unit waterline means a pipeline from the waterline exit to the connection portion with the city water supply pipe, even when the entire waterline is contained in the medical unit main body such as treatment unit, and part thereof is extended to the outside, it is regarded as the waterline of the unit.

In the apparatus of the construction as shown in FIG. 9, current sterilization was performed and its effect was checked. Conductivity of supply water was 25 mS/m, and total chloride ion concentration of water was 25 mg/L. To the main anode 5 and the auxiliary anode 41, from the DC current output apparatus, a voltage 18 V was applied to apply a current of 5.5 mA to the supply water. Further, for comparison, a test of applying the same amount of current only to the main anode was also performed. The results are shown in Table 18.

As can be seen from the Table, the construction in which each one of anode was provided before and after the electromagnetic valve (the auxiliary anode was additionally disposed at the upstream of the electromagnetic valve) is faster in revelation of sterilization effect.

TABLE 18

| | Observation | Before | After 4 | After 8 | After 16 | After 24 | After 52 |
|---|---|---|---|---|---|---|---|
| | item | mounting | weeks | weeks | weeks | weeks | weeks |
| Only main | Number of | 35000 | 7000 | 1500 | 340 | 70 | 30 |
| electrode | heterotroph | | | | | | |
| | bacteria * | | | | | | |
| | Residual | 0.00 | ≦0.02 | 0.03 | 0.07 | 0.1 | 0.2 |
| | chlorine | | | | | | |
| | conc. ** | | | | | | |
| Main | Number of | 37000 | 3500 | 450 | 30 | 10 | — |
| electrode | heterotroph | | | | | | |
| and | bacteria | | | | | | |
| auxiliary | Residual | 0.00 | ≦0.05 | 0.05 | 0.07 | 0.15 | 0.3 |
| electrode | chlorine | | | | | | |
| | conc. | | | | | | |

* Unit of the number of heterotroph bacteria: cfu/mL (PGY agar medium, cultivated at 26° C., for 7 days: according to city water test method)
** Unit of residual chlorine concentration: mg/L.

The method and apparatus for sterilization of medical unit waterline and water therein according to the present invention, when used for performing sterilization or deactivation or prevention of proliferation or growth of bacteria growing in medical unit waterline and water therein or on inner wall of water line, is possible to perform the object safely and effectively.

The present invention has been described in detail with respect to preferred embodiments, and it will now be apparent from the foregoing to those skilled In the art that changes and modifications may be made without departing from he invention in its broader aspects, and it is the intention, therefore, in the appended claims to cover all such changes and modifications as fall within the true spirit of the invention.

What is claimed is:

1. An electric current sterilization method for a medical unit waterline and water therein characterized in that
an anode electrode is disposed to expose in water in said waterline, and a cathode is connected to an outer surface of said waterline electrically conducting to an inner surface of said waterline or exposed in water in said waterline, and by these electrodes, an electric current of an output within the range from 3 to 50 mA is applied to water in said waterline.

2. The electric current sterilization method for a medical unit waterline and water therein as claimed in claim 1, wherein both electrodes of said anode and cathode are exposed in water, and application of electric current by these electrodes is performed by reversing positive and negative electrodes at every constant period of time.

3. The electric current sterilization method for a medical unit waterline and water therein as claimed in claim 1, wherein said anode is disposed at water supply side or waterline exit side of a closing valve within 5 m from said waterline exit for applying an electric current.

4. The electric current sterilization method for a medical unit waterline and water therein as claimed in claim 2, wherein said anode is disposed at water supply side or waterline exit side of a closing valve provided in said waterline within 5 m from said waterline exit for applying an electric current.

5. The electric current sterilization method for a medical unit waterline and water therein as claimed in claim 1, wherein at least two sets of said electrodes mounted to said medical unit are prepared, and an anode of mainly used one set of electrodes is disposed at waterline exit side of a closing valve provided in said waterline within 5 m from said waterline exit.

6. The electric current sterilization method for a medical unit waterline and water therein as claimed in claim 2, wherein at least two sets of said electrodes mounted to said medical unit are prepared, and an anode of mainly used one set of electrodes is disposed at waterline exit side of a closing valve provided in said waterline within 5 m from said waterline exit.

7. The electric current sterilization method for a medical unit waterline and water therein as claimed in claim 5, wherein an anode of at least one set of electrodes other than said always used electrodes of said at least two sots of electrodes is disposed at water supply side of a closing valve provided in said waterline, thereby providing rapid revelation of water sterilization action.

8. The electric current sterilization method for a medical unit waterline and water therein as claimed in claim 6, wherein an anode of at least one set of electrodes other than said always used electrodes of said at least two sets of electrodes is disposed at water supply side of a closing valve provided in said waterline, thereby providing rapid revelation of water sterilization action.

9. An electric current sterilization apparatus for a medical unit waterline and water therein characterized by comprising:
an anode electrode disposed to expose in water in said waterline;
a cathode electrode connected to an outer surface of said waterline electrically conducting to an inner surface of said waterline or exposed in water in said waterline; and
a DC current output apparatus for applying electric current of an output within the range from 3 to 50 mA through these electrodes to water in said waterline.

10. The electric current sterilization apparatus for a medical unit waterline and water therein as claimed in claim 9, wherein both electrodes of said anode and cathode are exposed in water, and application of electric current by these electrodes is performed by reversing positive and negative electrodes at every constant period of time.

11. The electric current sterilization apparatus for a medical unit waterline and water therein as claimed in claim 9, wherein said anode is disposed at water supply side or waterline exit side of a closing valve provided in said waterline within 5 m from said waterline exit.

12. The electric current sterilization apparatus for a medical unit waterline and water therein as claimed in claim 10, wherein said anode is disposed at water supply side or waterline exit side of a closing valve provided in said waterline within 5 m from said waterline exit.

13. The electric current sterilization apparatus for a medical unit waterline and water therein as claimed in claim 9, wherein at least two sets of said electrodes are provided as those mounted to said medical unit of which an anode of mainly used one set of electrodes is disposed at waterline exit side of a closing valve provided in said waterline within 5 m from said waterline exit.

14. The electric current sterilization apparatus for a medical unit waterline and water therein as claimed in claim 10, wherein at least two sets of said electrodes are provided as those mounted to said medical unit of which an anode of mainly used one set of electrodes is disposed at waterline exit side of a closing valve provided in said waterline within 5 m from said waterline exit.

15. The electric current sterilization apparatus for a medical unit waterline and water therein as claimed in claim 13, wherein an anode of at least one set of electrodes other than said always used electrodes of said at least two sets of electrodes is disposed at water supply side of a closing valve provided in said waterline.

16. The electric current sterilization apparatus for a medical unit waterline and water therein as claimed in claim 14, wherein an anode of at least one set of electrodes other than said always used electrodes of said at least two sets of electrodes is disposed at water supply side of a closing valve provided in said waterline.
